(19) United States
(12) Patent Application Publication
(10) Pub. No.: US 2016/0377054 A1
(43) Pub. Date: Dec. 29, 2016

(54) Stackable Compression & Venturi Diverter Vane

(71) Applicant: ENERDYNAMIC CORPORATION, Welland (CA)

(72) Inventor: Thomas Patrick Bryson, Brantford (CA)

(21) Appl. No.: 15/121,371

(22) PCT Filed: Feb. 25, 2015
(86) PCT No.: PCT/CA2015/000112

§ 371 Date: Aug. 24, 2016

Related U.S. Application Data
(60) Provisional application No. 61/944,113, filed on Feb. 25, 2014.

(51) Int. Cl. F03D 3/06; F03D 3/00; F03D 9/32; F03D 9/00

(52) U.S. Cl. CPC F03D 3/061; F03D 9/002; F03D 3/005; F03D 3/002; F03D 9/32; F05B 2240/21; F05B 2220/706; F05B 2240/911; F05B 2240/941

(57) ABSTRACT

A device for harvesting wind energy comprising curvilinear wind vanes mounted in a frame, each vane is stackable for handling, storage and transportation.

### TECHNICAL FIELD

The present disclosure relates to the field of renewable energy. In particular, the present disclosure relates to the harvesting of wind energy by means of vertical vanes that are instigated by wind current to rotate, thereby spinning a generator to produce electricity. Unlike conventional wind turbines and generators that use the principle of “dynamic lift” to induce rotation, (similar to the propeller on an aircraft) the present disclosure uses a plurality of compression and venturi effect to produce electricity.

### BACKGROUND

Wind has been harvested as a way of converting kinetic energy into a useable output of work for millennia, most commonly in sailing ships and windmills. In modern times, the focus on wind and wind-power has become synonymous with the “Green Energy” movement as a way of generating low carbon, renewable, eco-friendly electricity.

The applicant (Bryson) has disclosed and submitted patent applications previously on a wind generator that used “encapsulation” as the prescribed method of harvesting the flow of wind to maximize torque and induce rotation of the generator. The current disclosure is a departure from the static “capture and overflow” that is evident on the previous patent submission. The disclosure herein describes a fluid design which compresses “down-wind” airflow in the concave energy capture area of the vane. The compressed airflow is channelled with increased speed through a venturi like viaduct to divert the airflow into an adjacent vane cavity that is rotating in the “up-wind” direction. The benefit of this design reduces drag and increases rotational efficiency.

WO 2011/134054 (Bryson) discloses a hybrid wind-solar energy device comprising: a) a wind-capture assembly comprising: i) one or more wind sails evenly distributed circumferentially around a central axis thereof; and ii) a solar-energy capture means on an outer of the wind-capture assembly; and c) a turbine assembly comprising an anchoring based, an electrical generator, and an output shaft; the wind-capture assembly rotatably mounted on the output shaft and coupled thereto; the hybrid wind-solar energy device configured to convert energy harnessed by the wind-capture assembly to electrical energy, wherein interaction of the one or more wind sails with wind induces rotation of the wind-capture assembly and turbine assembly round the central axis; and the outer surface of the wind capture assembly is directly exposed to sunlight throughout daylight hours.

### BRIEF DESCRIPTION OF THE DRAWINGS

FIG. 1 is a diagram of a top view of an embodiment of the disclosed vanes.

FIG. 2 is a line diagram of a stack of an embodiment of the disclosed vanes.

FIG. 3 is an image of an embodiment of the disclosed vanes installed.

FIG. 4 is frontal view of an embodiment of the disclosed vanes.

### DETAILED DESCRIPTION

The current invention teaches a system of “wind only energy capture” utilizing a concave vane structure that compresses “down-wind” airflow in the energy capture area of the vane, and channels this compressed airflow with increased speed through a venturi like viaduct to divert the airflow into an adjacent vane that is rotating in the “up-wind” direction, thereby reducing drag and increasing efficiency by propelling the adjacent vane into the wind.

All existing vertical axis wind turbine technologies suffer from drag acting upon vanes that rotate into wind (called “upwind drag”). Rotation of the turbine occurs when incoming airflow pushes the vanes downwind for approximately 180 degrees (i.e. in the direction of the wind current). However, as the turbine continues to rotate beyond 180 degrees through 360 degrees, the vanes travel into the wind (i.e. “upwind”), thereby causing drag. The “windward ratio”, is a measure of the drag, based on the power generated by rotation in the downwind direction, minus the effect of friction and drag on the other half of the unit that is moving into the upwind direction.

A study of the present invention in a wind tunnel simulation reveals this dramatic effect.

Disclosed herein is a stackable, compression and venturi diverter type wind vane comprised of:

i) a concave energy capture and compression area,

ii) a venturi like viaduct diverter area,

iii) a convex energy deflector area,

for use in a vertical or horizontal wind turbine that provides for the generation of electricity wherein the design allows for the efficient operation without the need for external baffles or separate deflectors as disclosed on other wind turbines.

The wind turbine harvests kinetic energy from airflow acting upon the vane assembly causing the vane assembly to rotate. The entire vane assembly and frame are mounted to a vertical drive shaft that causes the centrally mounted output rotor shaft of the generator to turn inside the housing. The generator has a conventional stator, with a rotor which has a series of magnets radially affixed to it, and such rotation generates an electrical current output as the rotor magnets pass the stationary magnets and coils contained within the turbine housing.

In addition, disclosed herein is a dual turbine, cylindrical generator that allows the use of multiple high output generators which can be fitted to one or both ends or the centre shafts for vertical or horizontal vane assemblies.

The wind generator disclosed herein can be mounted onto a stationary or mobile body. The stationary embodiment of the device as disclosed herein can utilize positive or negative pressure airflow from the wind, while the embodiment where the device is attached to a vehicle utilizes positive airflow as a consequence of the vehicle moving.

Examples of a stationary body include (but are not limited to) the ground, on a building, atop a large advertising sign or highway notice board, a pole mount, etc.

Examples of a mobile body include (but are not limited to) a truck, a train, a bus, a car, a van, etc. Furthermore, where the device is mounted on to a mobile body, the height and tilt of the device are designed to allow the mobile body to comply with transportation regulations and clear tunnels, overpasses, bridges, and the like. In addition, the present device eliminates additional drag by fitting within the confines of the existing frontal area of the mobile body. The aerodynamic design of the device provides a smooth aero foil surface that further enhances the airflow over and around the moving vehicle.

Once the present device is affixed to a stationary or mobile host, electrical connections are made to transfer the output of the wind turbine assembly, via brushes, wires or such other method as practicable to send the generated current to an inverter, rectifier, control panel, battery bank or grid tied inverter.

The present device generates an electrical current from wind energy acting upon a vane assembly to induce rotation of a permanent magnet generator, although other types and configurations of generators, turbines, and alternators could be used effectively. A control panel management system stores and transforms wind energy as an alternating current of any required voltage. For example, the current can be directed to storage batteries; or can feed directly into a grid or other electrical usage as may be required.

The current invention as disclosed herein, a stackable, compression and venturi wind vane possesses numerous benefits over vanes in conventional wind energy systems. Conventional wind turbines require considerable tower requirements to elevate them to a workable height. This is often expensive, unsightly and difficult to service. The present device mounts directly onto a base and can be affixed at ground level, on a roof, on hi-way barriers, overhead signs, advertising placards, vehicle roofs, mobile applications or any location where portable power may be required.

The foregoing summarized the principal features of the compression and venturi vane wind generator, and some of its optional aspects. The device may be further understood by the descriptions of the embodiments which follow. Whenever ranges of values are referenced within this specification, sub ranges therein are intended to be included within the scope of the device unless otherwise stated. Where characteristics are attributed to one or another variant of the device, unless otherwise indicated, such characteristics are intended to apply to all other variants of the device where such characteristics are appropriate or compatible with such other variants.

According to one aspect, there is provided a stationary device for harvesting energy from an air current provided by positive air pressure from the wind, the device comprising:

a) one or more wind turbines,

b) each wind turbine comprising a vane assembly rotatably mounted on a horizontal shaft,

c) the horizontal shaft fitted on one or both ends with an electrical generator,

d) the vane assembly comprising a plurality of curvilinear vanes, minimum of 2 vanes,

e) the curvilinear vanes are stackable for efficient handling, storing and shipping.

In another aspect, there is provided a stationary device for harvesting energy from an air current provided by negative air pressure from an air make up unit designed to regulate air pressure inside a large building or a vacuum or pump apparatus, the device comprising:

a) one or more wind turbines,

b) each wind turbine comprising a vane assembly rotatably mounted on a horizontal shaft,

c) the horizontal shaft fitted on one or both ends with an electrical generator,

d) the vane assembly comprising a plurality of curvilinear vanes, minimum of 2 vanes,

e) the curvilinear vanes are stackable for efficient handling, storing and shipping.

In another aspect, there is provided a device mounted on a vehicle for harvesting energy from an air current provided by positive pressure from wind as the vehicle moves, the device comprising:

a) one or more wind turbines,

b) each wind turbine comprising a vane assembly rotatably mounted on a horizontal shaft,

c) the horizontal shaft fitted on one or both ends with an electrical generator,

d) the vane assembly comprising a plurality of curvilinear vanes, minimum of 2 vanes,

e) the curvilinear vanes are stackable for efficient handling, storing and shipping.

In yet another aspect, there is provided a stationary device for harvesting energy from an air current provided by positive air pressure from the wind, the device comprising:

a) one or more wind turbines,

b) each wind turbine comprising a vane assembly rotatably mounted on a vertical shaft,

c) the vertical shaft fitted on one or both ends with an electrical generator,

d) the vane assembly comprising a plurality of curvilinear vanes, minimum of 2 vanes,

e) the curvilinear vanes are stackable for efficient handling, storing and shipping.

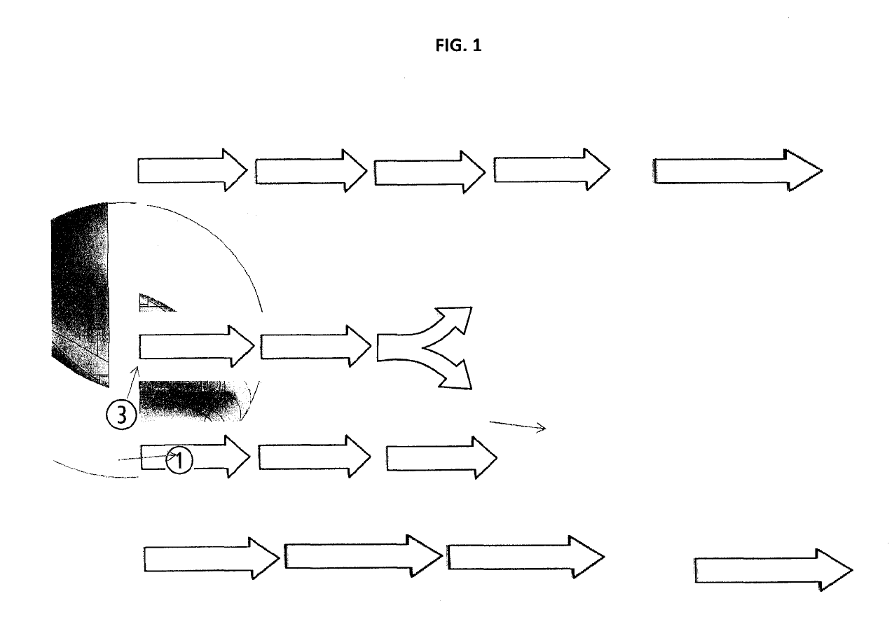

FIG. 1 shows a top view of the present invention, Stackable, Compression & Venturi Diverter Vanes in the preferred orientation, with each curvilinear vane 180 degrees opposed to the other.

The direction of the airflow acting upon the vanes to induce rotation in a counter clock-wise direction is travelling from the left to the right of the page as viewed and depicted by the arrows.

The vane shown top left, is the “Convex” Energy Deflector which reduces drag by deflecting the airflow around the leading edge of the vane. The deflector surface not only minimizes friction caused by the wind, but it channels said airflow into the adjacent concave energy capture and compression area.

The vane shown in the bottom right, is the “Concave” Energy Capture and Compression area that takes a large cross section of airflow and diverts it through a venturi like viaduct. This increased air pressure and velocity of the said airflow is diverted into the adjacent vane to propel it into the wind as shown with the curved arrows.

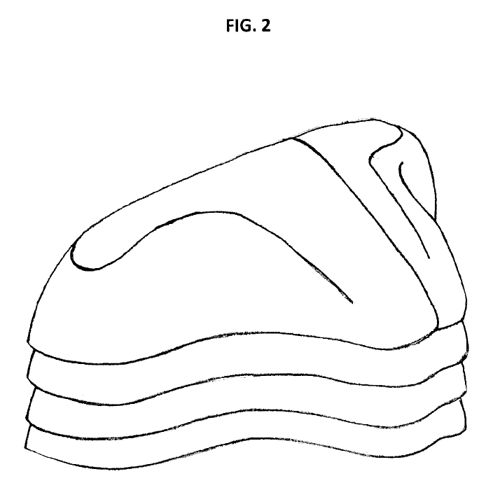

FIG. 2 shows the ability of the Compression and Venturi Diverter vane to be “Stackable”

This novel attribute allows the device to be easily handled, packaged and shipped to remote locations where the device will be used to generate electricity in a “micro-grid” environment.

The ability to stack the curvilinear wind vanes makes manufacturing much simpler by reducing the space required for finished product, and inventory.

Traditional wind vane technology is large and cumbersome to handle and transport, making their use in remote locations very difficult and expensive. The invention described herein is a novel and inventive step that circumvents the handling issues of existing wind turbine vanes.

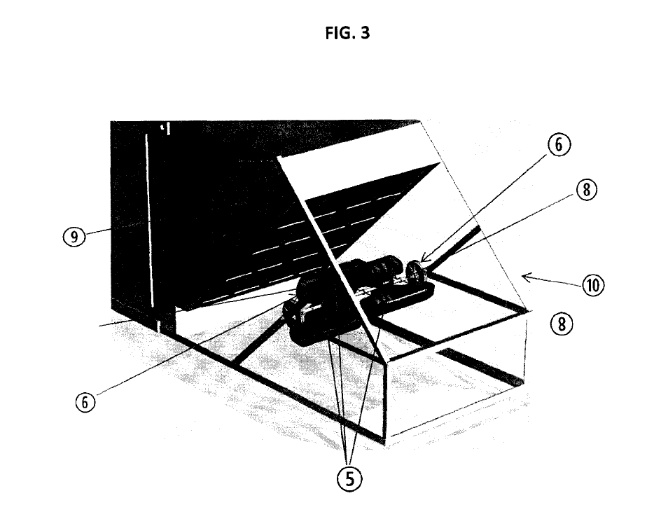

FIG. 3 depicts a stationary embodiment of the device as disclosed herein that can utilize negative pressure airflow. In this aspect, there is provided a stationary device for harvesting energy from an air current provided by negative air pressure from an air make up unit designed to regulate air pressure inside a large building or a vacuum or pump apparatus.

A device wherein a generator can be affixed to both ends of the shaft is shown in FIG. 3.

FIG. 3 further presents a device wherein a plurality of curvilinear wind vanes are rotatably mounted to a frame that is attached to a central drive shaft.

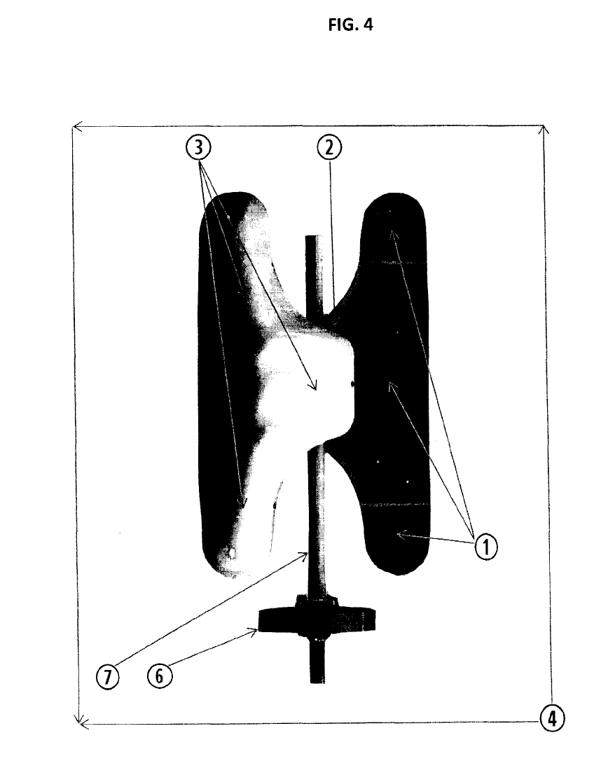

FIG. 4 is a frontal view of the Stackable Compression & Venturi Diverter vane assembly rotatably mounted on a vertical shaft, with a single generator affixed thereto.

### DESCRIPTION OF DRAWINGS COMPONENTS

1 Concave Energy Capture area
2 Venturi-like Viaduct Diverter
3 Convex Energy Deflector area
4 Vertical Vane Assembly
5 Horizontal Vane Assembly
6 Electrical Generator
7 Vertical Shaft
8 Horizontal Shaft
9 Air Make up Unit
10 Structural Frame

1. A device for harvesting energy from movement of air or liquid, the device comprising curvilinear wind vanes that are stackable.

2. The device in claim 1 wherein a plurality of curvilinear wind vanes are rotatably mounted to a frame that is attached to a central drive shaft with a single generator.

3. The device in claims 1 wherein the number of curvilinear wind vanes in a vane assemble can be from 2 to 48.

4. The device in claim 1 wherein a generator can be affixed to both ends of the shaft.

5. The device in claim 1 wherein the curvilinear wind vanes are made from plastic.

6. The device in claim 1 wherein the curvilinear wind vanes are made from metal.

7. The device in claim 1 wherein the curvilinear wind vanes can be used in either a horizontal or vertical orientation.

8. The device in claim 1 wherein the curvilinear wind vanes can be affixed in such a manner that the convex energy deflector area directs airflow into the concave energy capture and compression area of the adjacent vane in the vane assembly.

9. A device for harvesting energy from movement of air or liquid, the device comprising curvilinear wind vanes with a larger concave energy capture and compression area adjacent to a smaller venturi like viaduct diverter.

10. The device in claim 9 wherein the larger concave energy capture and compression area is designed to be exposed to down-wind airflow and divert said airflow into the smaller venturi like viaduct thereby causing an increase in air pressure and velocity of said airflow.

11. The device of claim 9 whereby the diverted high pressure and velocity airflow is directed into an adjacent vane that is rotating in the “up-wind” direction, thereby reducing drag and increasing efficiency by propelling the adjacent vane into the wind.

12. A stationary device for harvesting energy from a negative pressure air current, the device comprising, one or more wind turbines, each wind turbine comprising a vane assembly rotatably mounted on a structural frame, attached to a horizontal shaft, the vane assembly comprising a plurality of vanes, wherein the source of an air current is from exposure to an external mechanical air make up unit, vacuum pump or air suction device.

13. A stationary device for harvesting energy from an air current, the device comprising, one or more wind turbines, each wind turbine comprising a vane assembly rotatably mounted on a structural frame, the vane assembly comprising a plurality of vanes, wherein the source of an air current is from exposure to the wind.

14. The device of claim 13, wherein the device is configured and arranged to be mounted on a mobile body or a vehicle and the vane assembly is rotatably mounted on a horizontal shaft, and wherein the source of an air current is a consequence of the body or vehicle moving.

15. (canceled)

16. The device of claim 1 whereby the curvilinear vanes deflect and divert airflow without the need for additional baffles or deflectors as required on other wind turbines.

17. The device of claim 13, wherein the vane assembly is rotatably mounted on a vertical shaft.

18. The device of claim 13, wherein the vane assembly is rotatably mounted on a horizontal shaft.
